(19) United States
(12) Patent Application Publication
(10) Pub. No.: US 2012/0192566 A1
(43) Pub. Date: Aug. 2, 2012

(54) FUEL INJECTION ASSEMBLY FOR USE IN TURBINE ENGINES AND METHOD OF ASSEMBLING SAME

(76) Inventors: Jong Ho Uhm, Simpsonville, SC (US); David Leach, Simpsonville, SC (US); Thomas Edward Johnson, Greer, SC (US)

(21) Appl. No.: 13/016,760

(22) Filed: Jan. 28, 2011

(51) Int. Cl. F02C 7/22; B21D 51/16

(52) U.S. Cl. 60/740; 29/890.09

(57) ABSTRACT

A method for assembling a fuel injection assembly for use in a turbine engine is provided. The method includes providing a cap assembly that has at least one first opening extending at least partially through it and a plurality of second openings extending at least partially through it. Moreover, a plurality of tube assemblies are coupled within the cap assembly. Each tube assembly includes a plurality of tubes. Further, at least one injection system is coupled to the cap assembly to enable a fluid from a fluid source to be discharged through at least one of the plurality of second openings. The fluid flows between at least two adjacent tube assemblies to facilitate at least one of reducing a temperature within the cap assembly and reducing dynamic pressure oscillations within a combustor during operation of the turbine engine.

### FEDERAL RESEARCH STATEMENT

This invention was made with Government support under Contract No. DE-FC26-05NT42643, awarded by the Department of Energy (DOE), and the Government has certain rights in this invention.

### BACKGROUND OF THE INVENTION

The subject matter disclosed herein generally relates to turbine engines and, more particularly, to a fuel injection assembly for use in a turbine engine.

At least some known turbine engines are used in cogeneration facilities and power plants. Such engines may have high specific work and power per unit mass flow requirements. To increase the operating efficiency, at least some known turbine engines, such as gas turbine engines, operate with increased combustion temperatures. In at least some known gas turbine engines, engine efficiency increases as combustion gas temperatures increase.

However, operating with higher temperatures may also increase the generation of polluting emissions, such as oxides of nitrogen (NO_{X}). In an attempt to reduce the generation of such emissions, at least some known turbine engines include improved combustion system designs. More specifically, at least some known combustion systems are designed to operate with increased dynamic pressure oscillations. However, the benefits of such systems may be limited, as increased dynamic pressure oscillations may increase the noise generated by the combustion system, may increase the wear of the combustor, and/or may shorten the useful life of the combustion system.

Although multi-fuel combustion assemblies generally operate with reduced noise, such combustion systems may provide only limited performance results. For example, such systems may operate with high hydrogen gas levels that can induce a screech tone frequency of greater than 1 kHz. Such a screech frequency range may result in a flame behavior that causes as a coupling interaction between the nozzles within the combustion assembly. Such flame behavior may substantially increase the temperature within the combustion assembly and/or may induce vibrations throughout the combustion assembly and associated hardware components. Moreover, increased internal temperature and the vibrations induced into the combustion system may increase the wear of the combustor and associated components, and/or may shorten the useful life of the combustion system.

### BRIEF DESCRIPTION OF THE INVENTION

In one embodiment, a method for assembling a fuel injection assembly for use in a turbine engine is provided. The method includes providing a cap assembly that has at least one first opening extending at least partially through it and a plurality of second openings extending at least partially through it. Moreover, a plurality of tube assemblies are coupled within the cap assembly. Each tube assembly includes a plurality of tubes. Further, at least one injection system is coupled to the cap assembly to enable a fluid from a fluid source to be discharged through at least one of the plurality of second openings. The fluid flows between at least two adjacent tube assemblies to facilitate at least one of reducing a temperature within the cap assembly and reducing dynamic pressure oscillations within a combustor during operation of the turbine engine.

In another embodiment, a fuel injection assembly for use in a turbine engine is provided. The fuel injection assembly includes a cap assembly having at least one first opening extending at least partially through it and a plurality of second openings extending at least partially through it. The fuel injection assembly also includes a plurality of tube assemblies having a plurality of tubes. Each tube assembly is coupled within the cap assembly. The fuel injection assembly also includes at least one injection system coupled to the cap assembly. The injection system includes a fluid supply member coupled in flow communication between a fluid source and the cap assembly. The injection system is configured to discharge fluid through at least one of the plurality of second openings such that fluid flows between at least two adjacent tube assemblies to facilitate at least one of reducing a temperature within the cap assembly and reducing dynamic pressure oscillations within a combustor during operation of the turbine engine.

In another embodiment, a turbine engine is provided. The turbine engine includes a compressor and a combustion assembly coupled downstream from the compressor. The combustion assembly includes at least one combustor that includes at least one fuel injection assembly. The fuel injection assembly includes a cap assembly having at least one first opening extending at least partially through it and a plurality of second openings extending at least partially through it. The fuel injection assembly also includes a plurality of tube assemblies having a plurality of tubes. Each tube assembly is coupled within the cap assembly. The fuel injection assembly also includes at least one injection system coupled to the cap assembly. The injection system includes a fluid supply member coupled in flow communication between a fluid source and the cap assembly. The injection system is configured to discharge fluid through at least one of the plurality of second openings such that fluid flows between at least two adjacent tube assemblies to facilitate at least one of reducing the temperature within the cap assembly and reducing dynamic pressure oscillations within a combustor during operation of the turbine engine.

### BRIEF DESCRIPTION OF THE DRAWINGS

FIG. 1 is a schematic cross-sectional view of an exemplary turbine engine;

FIG. 2 is a schematic cross-sectional view of a portion of an exemplary fuel injection assembly that may be used with the turbine engine shown in FIG. 1 and taken along area 2;

FIG. 3 is an enlarged schematic cross-sectional view of a portion of the fuel injection assembly shown in FIG. 2 and taken along area 3;

FIG. 4 is a schematic cross-sectional view of a portion of the fuel injection assembly shown in FIG. 2 and taken along line 4-4; and

FIG. 5 is a schematic cross-sectional view of a portion of the fuel injection assembly shown in FIG. 2 and taken along line 5-5.

### DETAILED DESCRIPTION OF THE INVENTION

The exemplary methods, apparatus, and systems described herein overcome at least some known disadvantages associated with at least some known combustion systems of turbine engines that operate with higher temperatures and/or that induce vibrational energy therein and within its associated hardware components. The embodiments described herein provide a fuel injection assembly that may be used with turbine engines to facilitate substantially reducing the operating temperature and the dynamic pressure oscillations within a combustor. More specifically, the fuel injection assembly includes an injection system that enables a fluid to be injected into a combustion chamber such that the fluid is discharged adjacent to a center and/or outer fuel injection nozzles. Such an injection of the fluid facilitates disrupting and preventing any coupling interaction between a flame generated by the center fuel injection nozzle and a flame generated by an adjacent fuel injection nozzle in the fuel injection assembly. By disrupting the flame interaction between the adjacent nozzles, the fluid provides a barrier extending between the adjacent nozzles that facilitates substantially reducing the operating temperature and substantially reducing dynamic pressure oscillations within a combustor during operation of the turbine engine.

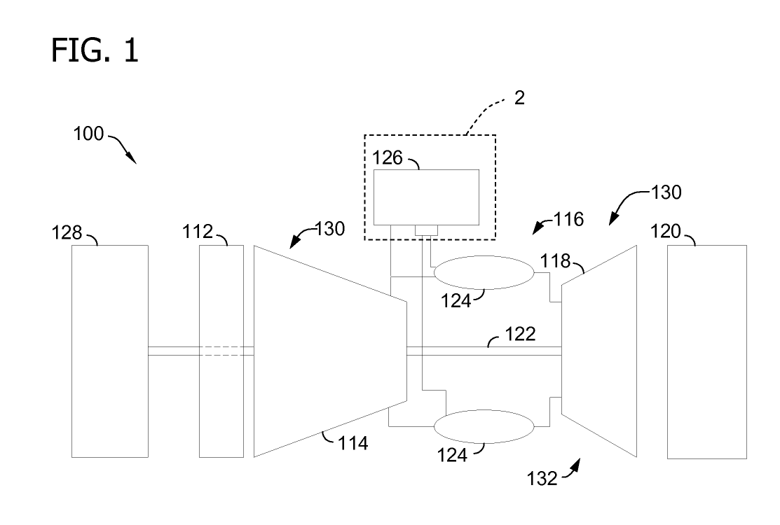

FIG. 1 is a schematic cross-sectional view of an exemplary turbine engine 100. More specifically, turbine engine 100 is a gas turbine engine. While the exemplary embodiment includes a gas turbine engine, the present invention is not limited to any one particular engine, and one of ordinary skill in the art will appreciate that the current invention may be used in connection with other turbine engines.

Moreover, in the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is positioned in flow communication with the compressor section 114. A fuel injection assembly 126 is coupled within each combustor 124. Turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132.

During operation, intake section 112 channels air towards compressor section 114 wherein the air is compressed to a higher pressure and temperature prior to being discharged towards combustor section 116. The compressed air is mixed with fuel and ignited to generate combustion gases that are channeled towards turbine section 118. More specifically, in combustors 124, fuel, for example, natural gas and/or fuel oil, is injected into the air flow, and the fuel-air mixture is ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132.

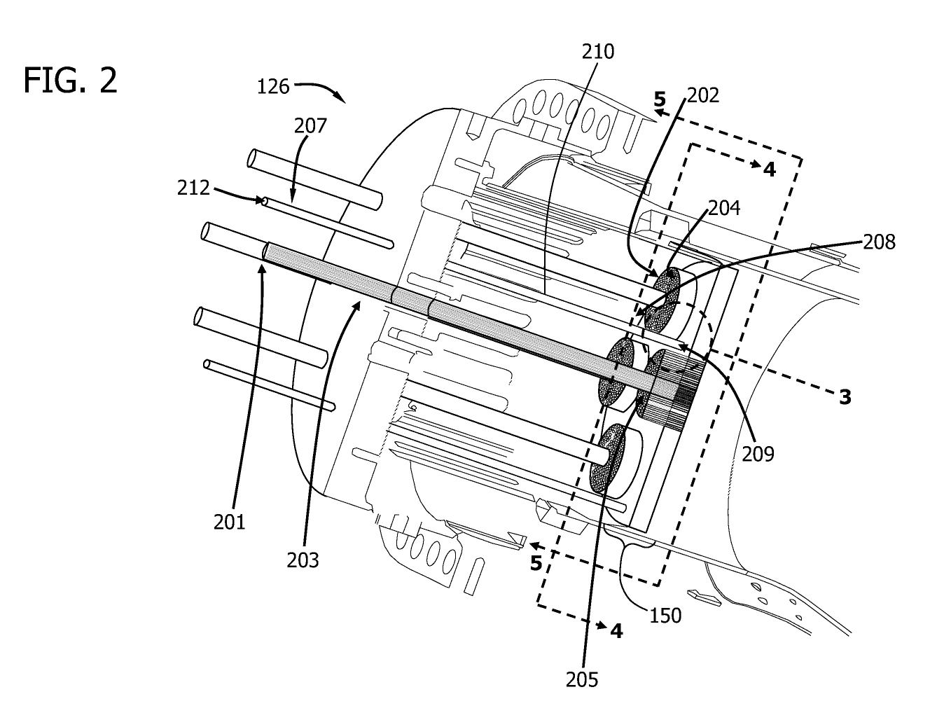

FIG. 2 is a cross-sectional view of a portion of fuel injection assembly 126 and taken along area 2 (shown in FIG. 1). In the exemplary embodiment, fuel injection assembly 126 includes a cap assembly 150 and a plurality of tube assemblies 202. In the exemplary embodiment, tube assemblies 202 are fuel injection nozzles that are each substantially axially coupled within cap assembly 150 and that each include a plurality of tubes 204. More specifically, in the exemplary embodiment, tube assemblies 202 are formed integrally with cap assembly 150. Alternatively, tube assemblies 202 are coupled to cap assembly 150.

In the exemplary embodiment, each tube 204 discharges a mixture of fuel and air channeled through a passage (not shown) in tube 204. Moreover, in the exemplary embodiment, each tube assembly 202 is coupled to a fuel delivery pipe 203. Fuel delivery pipe 203 includes a first end portion 201 that is coupled to a fuel source (not shown), and a second end portion 205 that is coupled to tube assembly 202.

Fuel injection assembly 126 also includes at least one injection system 208 that has a fluid supply member 210 coupled in flow communication between a fluid source 212 and cap assembly 150. More specifically, in the exemplary embodiment, fluid supply member 210 has a first end portion 207 that is coupled to fluid source 212, and a second end portion 209 that is coupled to cap assembly 150. In the exemplary embodiment, fluid supply member 210 has a substantially cylindrical cross-sectional shape that defines a linear flow path therethrough. Alternatively, fluid supply member 210 may have any shape that defines any flow path(s) that enable fluid supply member 210 to fit within fuel injection assembly 126 and to function as described herein.

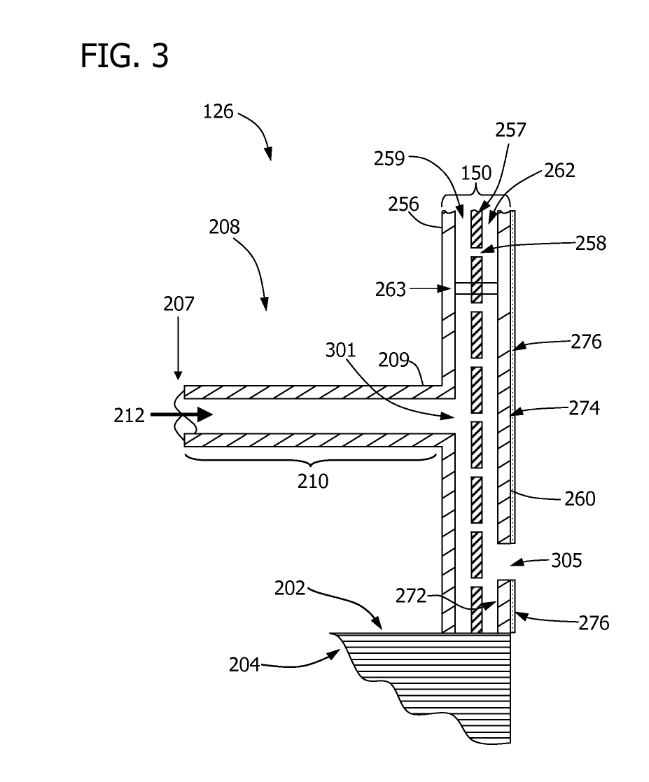

FIG. 3 is an enlarged cross-sectional view of a portion of fuel injection assembly 126 taken along area 3 (shown in FIG. 2). Fuel injection assembly 126 includes cap assembly 150. In the exemplary embodiment, cap assembly 150 includes an upstream portion 256 that is adjacent to at least one tube assembly 202. Moreover, cap assembly 150 includes an impingement plate 257 that includes a plurality of openings 258 defined therein and extending therethrough. In the exemplary embodiment, impingement plate 257 is coupled to upstream portion 256 such that a first channel 259 is defined therebetween. Cap assembly 150 also includes a downstream portion 260 coupled to impingement plate 257 such that a second channel 262 is defined therebetween. Moreover, in the exemplary embodiment, a divider 263 is coupled within cap assembly 150 and extends between upstream portion 256 and downstream portion 260.

Moreover, in the exemplary embodiment, downstream portion 260 includes a first surface 272 and a second surface 274. A thermal barrier coating 276 is applied across second surface 274. In the exemplary embodiment, thermal barrier coating 276 includes a plurality of layers (not shown) that include at least a metallic bond coating, a thermally prepared oxide, and a ceramic top coating (each not shown). Alternatively, coating 276 may include any components that enable coating 276, fuel injection assembly 126, and turbine engine 100 to function as described herein.

In the exemplary embodiment, coating 276 is applied across second surface 274 via a spray process that facilitates substantially evenly distributing a layer of coating 276 across surface 274. Alternatively, coating 276 may be applied across surface 274 and/or impregnated thereon using any method known in the art that enables coating 276, fuel injection assembly 126, and turbine engine 100 to function as described herein.

Moreover, in the exemplary embodiment, cap assembly 150 includes at least one first opening 301 that extends at least partially through cap assembly 150 and a plurality of second openings 305 that each extend at least partially through cap assembly 150. In FIG. 3, only one first opening 301 and only one second opening 305 are shown. More specifically, in the exemplary embodiment, first opening 301 extends through upstream portion 256, and second opening 305 extends through downstream portion 260. Moreover, in the exemplary embodiment, second opening 305 is spaced downstream from first opening 301.

In the exemplary embodiment, fuel injection assembly 126 includes injection system 208. Moreover, injection system 208 includes fluid supply member 210 that is coupled in flow communication between fluid source 212 and cap assembly 150. More specifically, in the exemplary embodiment, fluid supply member 210 is coupled to upstream portion 256 of cap assembly 150. Moreover, in the exemplary embodiment, second end portion 209 is inserted into opening 301 such that fluid discharged from fluid supply member 210 is channeled through upstream portion 256.

In the exemplary embodiment, fluid source 212 is used to channel various fluids. For example, steam and inert gases, such as inert gases that are used primarily in high momentum jets, nitrogen and carbon dioxide may be channeled from source 212. Moreover, diluents, such as air, may be used. Moreover, a combination of inert gases and diluents can be used. For example, nitrogen may be used with carbon dioxide. Alternatively, nitrogen may be used with air.

During operation, fuel supplied to tube assemblies 202 and is mixed with air to form a combustible mixture. At the same time, fluid flow is supplied via injection system 208 to second opening 305. More specifically, in the exemplary embodiment, fluid is channeled from fluid source 212 to first end portion 207 of fluid supply member 210. The fluid is then channeled through fluid supply member 210 towards second end portion 209.

In the exemplary embodiment, fluid then flows from second end portion 209 through first opening 301 and into first channel 259. First channel 259 is oriented such that fluid flow is directed into impingement plate openings 258. Impingement plate openings 258 enable fluid to be evenly distributed into second channel 262 that is oriented such that fluid flow is then directed into second opening 305. More specifically, in the exemplary embodiment, impingement plate openings 258 enable fluid to be evenly distributed into second channel 262 such that fluid is evenly distributed along downstream first surface 272 and to evenly reduce the temperature of downstream second surface 274, thereby obtaining enhanced cooling efficiency.

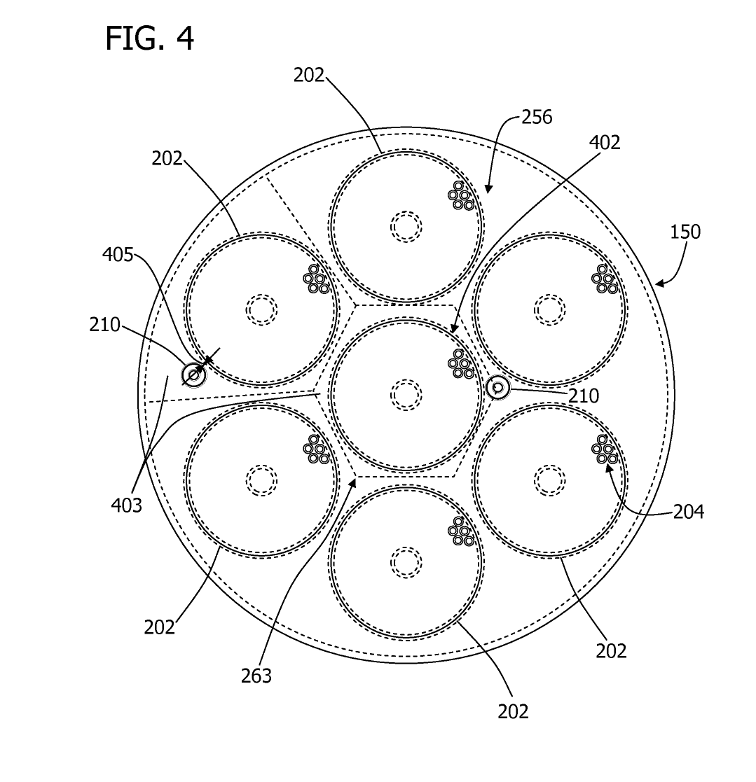

FIG. 4 is a schematic cross-sectional view of a portion of fuel injection assembly 126 taken along line 4-4 (shown in FIG. 2). In the exemplary embodiment, tube assemblies 202 include a central tube assembly 402. Moreover, tube assemblies 202 and central tube assembly 402 are coupled within cap assembly upstream portion 256. More specifically, in the exemplary embodiment, tube assemblies 202 and 402 are formed integrally with cap assembly 150. Alternatively, tube assemblies 202 and 402 may be detachably coupled to cap assembly 150. Moreover, in the exemplary embodiment, although each tube assembly 202 and 402 is shown as having only five tubes 204, alternatively, each tube assembly 202 and 402 can have any number of tubes 204 that enables each tube assembly 202 and 402 to function as described herein.

In the exemplary embodiment, tube assemblies 202 are spaced circumferentially about central tube assembly 402 within upstream portion 256 of cap assembly 150. Alternatively, tube assemblies 202 may be arranged in any orientation that enables tube assemblies 202 to function as described herein.

Moreover, in the exemplary embodiment, fluid supply member 210 is positioned adjacent to central tube assembly 402 such that fluid supply member 210 is coupled in flow communication between fluid source 212 (shown in FIGS. 2 and 3) and cap assembly 150, allowing for fluid to be distributed through a plurality of openings 258 on impingement plate 257, to reduce the temperature of second surface 274, and to be discharged into at least one second opening 305 (shown in FIG. 3).

In the exemplary embodiment, one fluid supply member 210 is spaced adjacent to central tube assembly 402. Moreover, at least one fluid supply member 210 is spaced adjacent to at least one outer tube assembly 202. In the exemplary embodiment, divider 263 is annular and substantially circumscribes central tube assembly 404. Moreover, divider 263 defines a portion 403 on second surface 274 that surrounds at least one outer tube assembly 202 to enable the temperature to be reduced on portion 403, as described above. Alternatively, fluid supply members 210 may be oriented in any orientation that enables fluid supply members 210 to function as described herein.

In the exemplary embodiment, each fluid supply member 210 is coupled to cap assembly 150 to ensure that each fluid supply member 210 is positioned a distance 405 from tube assembly 202. Moreover, in the exemplary embodiment, each fluid supply member 210 is positioned in relatively close proximity to an adjacent tube assembly 202. Alternatively, a connecting device (not shown) may be used that enables each fluid supply member 210 is couple to both cap assembly 150 and an adjacent tube assembly 202. For example, a manifold (not shown) may be used to couple fluid supply member 210 to an adjacent tube assembly 202. Moreover, in one embodiment, the manifold includes a plurality of fluid supply members 210 that are coupled to each other such that fluid supply members 210 are spaced circumferentially about tube assemblies 202.

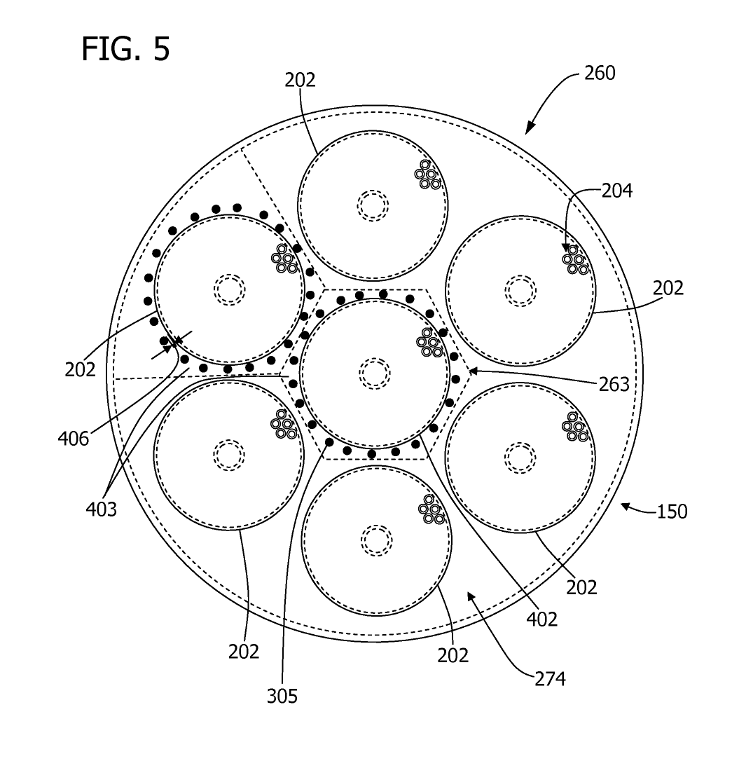

FIG. 5 is a schematic cross-sectional view of a portion of fuel injection assembly 126 taken along line 5-5 (shown in FIG. 2). In the exemplary embodiment, tube assemblies 202 and central tube assembly 402 are coupled within cap assembly downstream portion 260. More specifically, in the exemplary embodiment, tube assemblies 202 and 402 are coupled within second surface 274 of downstream portion 260.

In the exemplary embodiment, tube assemblies 202 are spaced circumferentially about central tube assembly 402 within cap assembly downstream portion 260. Alternatively, tube assemblies 202 may be arranged in any orientation that enables tube assemblies 202 to function as described herein.

In the exemplary embodiment, each second opening 305 is spaced adjacent a distance 406 to at least one tube assembly 202. More specifically, second openings 305 are spaced circumferentially about central tube assembly 402 and second openings 305 are spaced circumferentially about one adjacent tube assembly 202.

During operation, fluid flows through impingement plate openings, fills at least one portion 403 defined by divider 263 and flows through each second opening 305. In the exemplary embodiment, fluid is discharged through each second opening 305 about the central tube assembly 402 and an adjacent outer tube assembly 202. The fluid being discharged through each second opening 305 about the central tube assembly 402 prevents central tube assembly 402 from interacting with at least one of the circumferentially spaced adjacent tube assemblies 202. More specifically, the fluid facilitates disrupting the coupling interaction between a flame generated by central tube assembly 402 and a flame generated by at least one of the circumferentially spaced adjacent tube assemblies 202. Similarly, in the exemplary embodiment, fluid being discharged through each second opening 305 about outer tube assembly 202 prevents outer tube assembly 202 from interacting with at least one other adjacent outer tube assembly 202.

Moreover, in the exemplary embodiment, by reducing the flame interaction between adjacent tube assemblies 202, the temperature of cap assembly 150 is reduced. Further, by disrupting the flame interaction between adjacent tube assemblies 202, the fluid provides a barrier between adjacent tube assemblies 202. The barrier created by the fluid acts as a sound baffle for each tube assembly 202 the fluid surrounds and dynamic pressure oscillations in combustor 106 (shown in FIG. 1) are reduced.

The above-described fuel injection assembly may be used with turbine engines to facilitate reducing the operating temperature generated and substantially reducing dynamic pressure oscillations within a combustor. More specifically, the fuel injection assembly includes an injection system that injects a fluid into a combustion chamber in a direction such that the fluid is adjacent to a center and/or outer fuel injection nozzles. Such fluid injection facilitates the disruption of any coupling interaction between a flame generated by the center fuel injection nozzle and a flame generated by at least one adjacent fuel injection nozzle in the fuel injection assembly. The fluid provides a barrier between the adjacent nozzles that disrupts the flame interaction between the adjacent nozzles such that the operating temperature is facilitated to be reduced and such that dynamic pressure oscillations are also facilitated to be reduced within the combustor during operation of the turbine engine.

Exemplary embodiments of a fuel injection assembly and method of assembling same are described above in detail. The fuel injection assembly and method of assembling same are not limited to the specific embodiments described herein, but rather, components of the fuel injection assembly and/or steps of the injection assembly may be utilized independently and separately from other components and/or steps described herein. For example, the fuel injection assembly may also be used in combination with other machines and methods, and is not limited to practice with only a turbine engine as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for assembling a fuel injection assembly for use with a turbine engine, said method comprising:
providing a cap assembly that includes at least one first opening extending at least partially therethrough and a plurality of second openings extending at least partially therethrough;
coupling a plurality of tube assemblies within the cap assembly, wherein each of the plurality of tube assemblies include a plurality of tubes; and
coupling at least one injection system to the cap assembly to enable a fluid from a fluid source to be discharged through at least one of the plurality of second openings, such that the fluid flows between at least two adjacent tube assemblies to facilitate at least one of reducing a temperature within the cap assembly and reducing dynamic pressure osciallations within a combustor during operation of the turbine engine.

2. A method in accordance with claim 1, wherein providing a cap assembly further comprises providing a cap assembly that includes an upstream portion, an impingement plate coupled to the upstream portion, and a downstream portion coupled to the impingement plate.

3. A method in accordance with claim 2, further comprising:
coupling the upstream portion to the impingement plate such that a first channel is defined therebetween, wherein the at least one first opening extends through the upstream portion and is defined adjacent to at least one of the plurality of tube assemblies; and
coupling the downstream portion to the impingement plate such that a second channel is defined therebetween, wherein the plurality of second openings extend through the downstream portion and are spaced circumferentially about at least one of the plurality of tube assemblies.

4. A method in accordance with claim 3, further comprising:
coupling a divider within the cap assembly such that the divider extends from the upstream portion to the downstream portion, wherein the divider substantially circumscribes the at least one first opening and the plurality of second openings;
orienting the first channel to direct fluid flow into the impingement plate openings; and
orienting the second channel to facilitate reducing the temperature of a portion of the cap assembly defined by the divider between at least two adjacent tube assemblies and to direct fluid flow into at least one of the plurality of second openings and between at least two adjacent tube assemblies.

5. A method in accordance with claim 3, further comprising coupling a fluid supply member to the upstream portion such that the at least one injection system discharges fluid flow into the first channel from the fluid supply member through the at least one first opening.

6. A method in accordance with claim 2, further comprising applying a thermal barrier coating across at least a portion of a surface of the downstream portion.

7. A method in accordance with claim 1, wherein coupling the at least one injection system to the cap assembly further comprises coupling the fluid source to the cap assembly, wherein the fluid source contains at least one of a diluent source and an inert gas source.

8. A fuel injection assembly for use in a turbine engine, said fuel injection assembly comprising:
a cap assembly comprising at least a first opening extending at least partially therethrough and a plurality of second openings extending at least partially therethrough;
a plurality of tube assemblies coupled within said cap assembly, each of said plurality of tube assemblies comprising a plurality of tubes; and
at least one injection system coupled to said cap assembly, wherein said injection system comprises a fluid supply member coupled in flow communication between a fluid source and said cap assembly, said at least one injection system configured to discharge fluid through at least one of said plurality of second openings, wherein the fluid flows between at least two adjacent tube assemblies to facilitate at least one of reducing a temperature within said cap assembly and reducing dynamic pressure oscillations within a combustor during operation of said turbine engine.

9. A fuel injection assembly in accordance with claim 8, wherein said cap assembly further comprises:
an upstream portion, wherein said at least one first opening extends through said upstream portion adjacent to at least one of said plurality of tube assemblies;
an impingement plate coupled to said upstream portion such that a first channel is defined therebetween, wherein said impingement plate comprises a plurality of openings; and
a downstream portion coupled to said impingement plate such that a second channel is defined therebetween, said plurality of second openings extend through said downstream portion and are spaced circumferentially about at least one of said plurality of tube assemblies, wherein the fluid flows between at least two adjacent tube assemblies.

10. A fuel injection assembly in accordance with claim 9, wherein said first channel is oriented to direct fluid flow into said impingement plate openings, said second channel is oriented to direct fluid flow into at least one of said plurality of second openings.

11. A fuel injection assembly in accordance with claim 9, further comprising a divider coupled within said cap assembly such that the divider extends from the upstream portion to the downstream portion, said divider substantially circumscribes said at least one first opening and said plurality of second openings, wherein fluid flows into a portion of said cap assembly defined by said divider.

12. A fuel injection assembly in accordance with claim 9, wherein said downstream portion comprises a first surface and a second surface, wherein a thermal barrier coating is applied across at least a portion of said second surface.

13. A fuel injection assembly in accordance with claim 9, wherein said at least one injection system is oriented to enable fluid flow to be discharged into said first channel from the fluid supply member through the at least one first opening.

14. A fuel injection assembly in accordance with claim 8, wherein said fluid source contains at least one of a diluent and an inert gas.

15. A turbine engine, said turbine engine comprising:
a compressor;
a combustion assembly coupled downstream from said compressor, wherein said combustion assembly comprises at least one combustor comprising a fuel injection assembly comprising:
a cap assembly comprising at least a first opening extending at least partially therethrough and a plurality of second openings extending at least partially therethrough;
a plurality of tube assemblies coupled within said cap assembly, each of said plurality of tube assemblies comprising a plurality of tubes; and
at least one injection system coupled to said cap assembly, wherein said injection system comprises a fluid supply member coupled in flow communication between a fluid source and said cap assembly, said at least one injection system configured to discharge fluid through at least one of said plurality of second openings, wherein the fluid flows between at least two adjacent tube assemblies to facilitate at least one of reducing a temperature within said cap assembly and reducing dynamic pressure oscillations within a combustor during operation of said turbine engine.

16. A turbine engine in accordance with claim 15, wherein said cap assembly further comprises:
an upstream portion, wherein said at least one first opening extends through said upstream portion and is adjacent to at least one of said plurality of tube assemblies;
an impingement plate coupled to said upstream portion such that a first channel is defined therebetween, wherein said impingement plate comprises a plurality of openings; and
a downstream portion coupled to said impingement plate such that a second channel is defined therebetween, wherein said plurality of second openings extend through said downstream portion and are spaced circumferentially about at least one of said plurality of tube assemblies.

17. A turbine engine in accordance with claim 16, wherein said first channel is oriented to direct fluid flow into said impingement plate openings and said second channel is oriented to direct fluid flow into at least one of said plurality of second openings.

18. A turbine engine in accordance with claim 16, further comprising a divider coupled within said cap assembly such that the divider extends from the upstream portion to the downstream portion, said divider substantially circumscribes said at least one first and said plurality of second openings, wherein fluid flows into a portion of said cap assembly defined by said divider.

19. A turbine engine in accordance with claim 16, wherein said downstream portion comprises a first surface and a second surface, wherein a thermal barrier coating is applied across at least a portion of said second surface.

20. A turbine engine in accordance with claim 15, wherein said fluid source contains at least one of a diluent and an inert gas.
